(19) United States
(12) Patent Application Publication
(10) Pub. No.: US 2010/0110602 A1
(43) Pub. Date: May 6, 2010

(54) ELECTRIC FIELD CONTROL METHODS AND APPARATUSES FOR CORONA WIND FANS

(75) Inventor: Daniel Jon SCHLITZ, Northbrook, IL (US)

Correspondence Address: PILLSBURY WINTHROP SHAW PITTMAN LLP, P.O. BOX 10500, MCLEAN, VA, 22102, US

(73) Assignee: Ventiva, Inc., Santa Clara, CA (US)

(21) Appl. No.: 12/582,478

(22) Filed: Oct. 20, 2009

Related U.S. Application Data
(60) Provisional application No. 61/110,834, filed on Nov. 3, 2008.

(51) Int. Cl. H01T 23/00

(52) U.S. Cl. 361/230; 315/111.81

(57) ABSTRACT

The present invention is a method of controlling the electric field in a corona wind fan to eliminate sparks and thereby increase the operating window and mechanical output of the device. A corona wind device moves a gas using ions that are generated by two electrodes. The electric field in a corona wind system is highly non-uniform. An intense field, of limited size, is needed to generate ions. It is desirable for the remainder of the system to be at as low a field as possible so as to prevent sparks from forming between electrodes. A contoured collector electrode creates this desirable electric field over most of a corona wind device. However, the electric field at the edges and ends of a contoured collector remain as weak points in the device. If not addressed, sparks will form prematurely at these points limiting the overall performance. Several methods to control the field at these points were developed.

### CROSS-REFERENCE TO RELATED APPLICATIONS

The present Application claims priority from U.S. Provisional Patent Application No. 61/110,834 filed Nov. 3, 2008 which application is expressly incorporated by reference herein in its entirety.

### FIELD OF THE INVENTION

The present invention is related to electro-hydrodynamic (EHD) techniques, and more particularly to methods and apparatuses for electric field control in EHD devices such as corona wind fans.

### BACKGROUND

A corona wind fan (also referred to herein as an ion wind fan) consists of one or more corona (small) and collecting (large) electrodes. A voltage is applied between the two electrodes causing a partial breakdown of the gas, referred to as a corona discharge, near the corona electrode. The discharge produces ions which are attracted to the collecting electrode. En route, the ions collide with neutral gas molecules creating pressure head and flow similar to that produced by a mechanical fan.

A contoured collecting electrode is described in co-pending application Ser. No. 12/017,986, the contents of which are incorporated by reference herein. The co-pending application further describes a method of producing a highly non-uniform electric field that maximized the rate of ion generation while minimizing the likelihood of spark formation. An intense field is created at the small, corona electrode. This field is sufficient in strength to ionize the gas. The geometry of the large, contoured collecting electrode forces the electric field to decrease rapidly with the distance from the corona electrode. In this way, with the exception of the region immediately adjacent to the corona electrode, the electric field strength in the corona wind device is well below the ionization point of the gas. Sparks cannot penetrate through the gas gap and the system is able to produce good gas flow.

The present inventors have recognized a weakness of this structure at the ends and edges of the contoured, collecting electrode. Whereas most of the device is under the influence of a one-dimensional, radially or spherically decreasing electric field, the field at the ends or edges is subjected to a two- or three-dimensional concentration of electric field lines. This creates a secondary point of intensified electric field, opposite from the corona electrode, which encourages sparking. FIG. 1 is a two-dimensional illustration of a wire-to-cylinder type of geometry that shows the secondary electric field concentrations near the collector electrodes. FIG. 1 shows a wire corona electrode 2 from a cross-sectional view and a half-cylinder shaped collector electrode 6. At the cylindrical portions of the collector electrode 6 there is a low electric field 8, but the sharp corner of the half-cylinder shape can result in a higher electric field concentration 4.

### SUMMARY OF THE INVENTION

The present invention is a method of controlling the electric field in a corona wind fan to eliminate sparks and thereby increase the operating window and mechanical output of the device. A corona wind device moves a gas using ions that are generated by two electrodes. The electric field in a corona wind system is highly non-uniform. An intense field, of limited size, is needed to generate ions. It is desirable for the remainder of the system to be at as low a field as possible so as to prevent sparks from forming between electrodes. A contoured collector electrode creates this desirable electric field over most of a corona wind device. However, the electric field at the edges and ends of a contoured collector remain as weak points in the device. If not addressed, sparks will form prematurely at these points limiting the overall performance. Several methods to control the field at these points were developed.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a two-dimensional illustration of a wire-to-cylinder type of geometry that shows the secondary electric field concentrations near the collector electrodes.

FIG. 2A illustrates an embodiment of this invention including a rounded section at the azimuthal edge of a radially contoured electrode.

FIG. 2B illustrates an embodiment of this invention being a corollary of FIG. 2A for a spherically contoured device.

FIG. 3 illustrates another embodiment of the invention that addresses the field concentration found at the axial ends of the contoured collector electrode.

FIG. 4 illustrates an embodiment of the present invention that eliminates field enhancement by terminating the active portion of the corona electrode inside of the collector electrode.

FIGS. 5A and 5B illustrates alternative embodiments according to the invention. FIG. 5A shows one or both ends of the corona wire bent upwards at the point where the wire is cut in FIG. 4. Alternatively, in FIG. 5B, the wire can be suspended as shown in FIG. 3, but the ends of the wire are covered with a dielectric insulator.

FIG. 6 illustrates an embodiment of the present invention that reduces or eliminates the field concentration at the ends of the collector electrode.

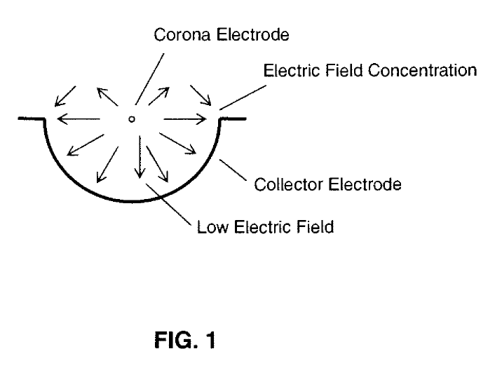

### DETAILED DESCRIPTION OF THE PREFERRED EMBODIMENTS

Generally, the present invention is aimed at controlling the electric field in a corona wind fan (also referred to herein as an ion wind fan) to eliminate sparks and thereby increase the operating window and mechanical output of the device. The electric field in a corona wind system is highly non-uniform. An intense field, of limited size, is needed to generate ions. It is desirable for the remainder of the system to be at as low a field as possible so as to prevent sparks from forming between electrodes. A contoured collector electrode creates this desirable electric field over most of a corona wind device. However, the electric field at the edges and ends of a contoured collector remain as weak points in the device. If not addressed, sparks will form prematurely at these points limiting the overall performance. Several methods to control the field at these points are described herein.

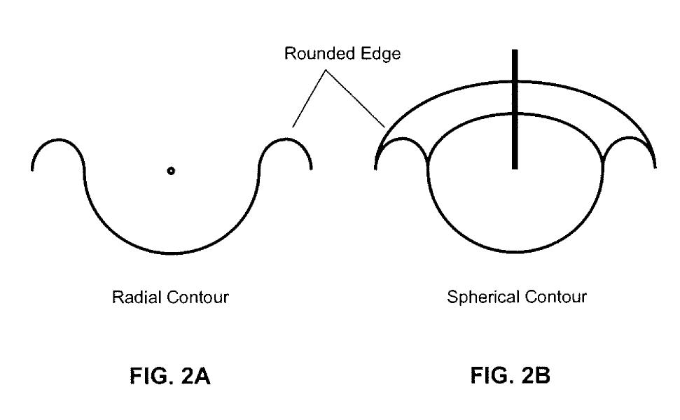

An embodiment of this invention is the addition of a rounded section at the azimuthal edge of a radially contoured electrode (FIG. 2A). In FIG. 2A a wire corona electrode 10 (shown in cross-sectional view) is disposed along the length of a substantially half-cylindrical shaped collector electrode. The azimuthal edge 16 of the collector 12 is rounded so that there are no sharp corners on the collector 12 facing the corona electrode 10.

Also shown is the corollary for a spherically contoured device (FIG. 2B). In FIG. 2B a pin-type corona electrode 14 (shown in side view) is disposed pointing substantially into a bowl-shaped half-spherical collector electrode 18. Once again, the azimuthal edge 16 of the collector 18 is rounded so that there are no sharp corners on the collector 18 facing the corona electrode 14. The radius of the rounded section can vary. The figure shows a ½ round feature, but any rounded section will improve (decrease) the electric field strength at the edge.

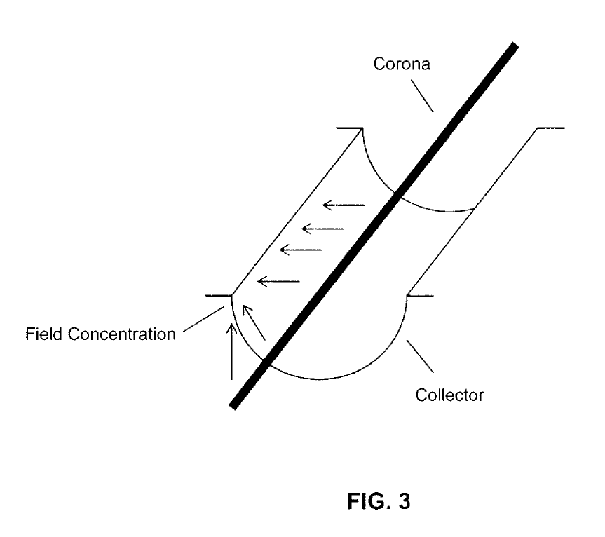

Another embodiment addresses the field concentration found at the axial ends of the contoured collector electrode. FIG. 3 shows the electric field concentration 24 that is found at the axial ends of the collector electrode 22. Field lines from the ends of the corona wire 20 focus back on the edge and corner of the collector, creating a region of enhanced electric field 24.

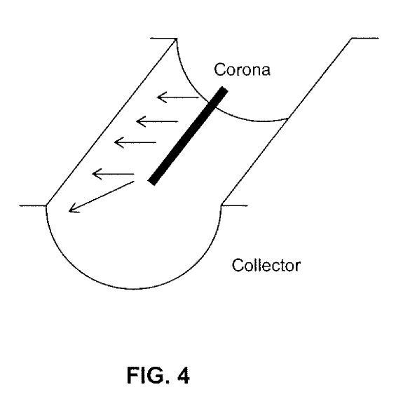

An embodiment of the present invention eliminates this field enhancement by terminating the active portion of the corona electrode inside of the collector electrode (FIG. 4). Field lines from this embodiment do not concentrate at the axial ends of the collector. This compensates for, or eliminates the electric field concentration at the end points. There are many ways to achieve this embodiment. The corona wire 26 can simply be cut short, as shown in FIG. 4. However, the wire generally requires mechanical support and also must be electrically connected to a power source.

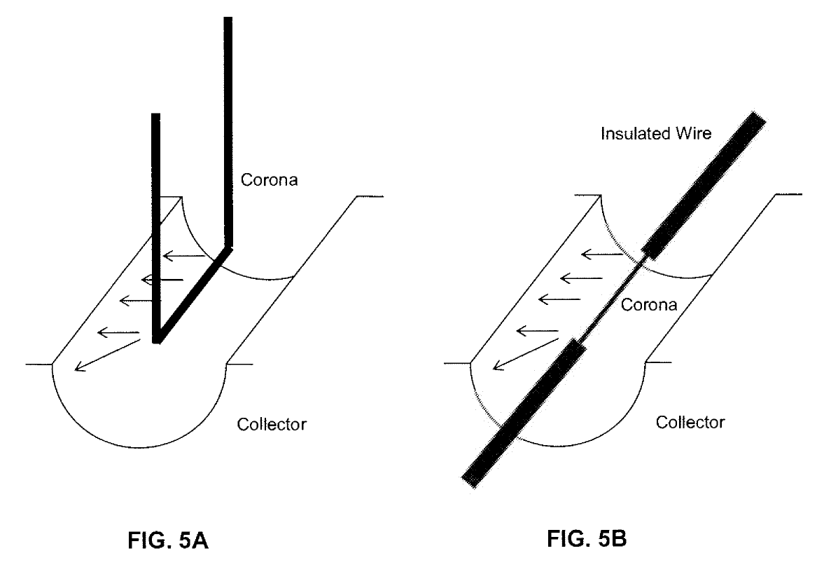

Given these practical considerations, alternative embodiments are shown in FIGS. 5A and 5B. FIG. 5A shows one or both ends of the corona wire 30 bent upwards at the point where the active portion of the corona wire 30 is terminated in the example in FIG. 4. This section of wire can then be connected to a remote power source or power bus. Alternatively, in FIG. 5B, the wire 32 can be suspended as shown in FIG. 3, but the ends of the wire are covered with a dielectric insulator creating an insulated portion 34 at one or both ends of the corona electrode 32 and an active exposed portion 36 in the center portion of the corona electrode 32. Only the exposed wire in the middle section is active and thus the cut wire effect of FIG. 4 is achieved.

After being taught by the present disclosure, those skilled in the art will recognize that there are a variety of combinations and variations of the methods employed in FIGS. 4 and 5 that will also give the same results. Examples include, but not limited to insulating the bent wire in FIG. 5A, terminating one end of the wire in either FIG. 5A or 5B, changing the direction of the bend in FIG. 5B, etc

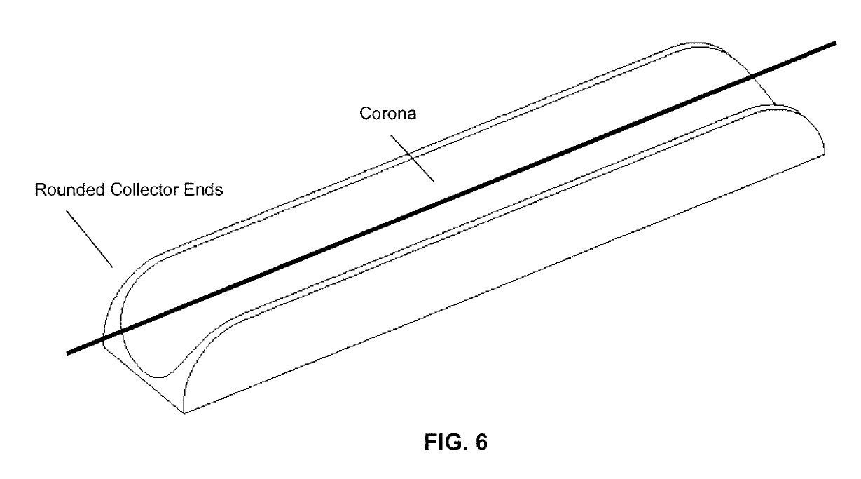

Another embodiment of the present invention that reduces or eliminates the field concentration at the ends of the collector electrode is shown in FIG. 6. The sharp corner at the axial and azimuthal end of the collector 40 has been rounded, thus spreading the incoming field lines that would otherwise concentrate at the sharp corner. The wire corona electrode 38 can once again be disposed lengthwise along the semi-cylindrical portion of the collector electrode 40. This embodiment can further be used in concert with previously detailed embodiments.

One advantage of controlling the electric field at the surface of the collector electrode, such that field concentrations are minimized or eliminated, is in the suppression of sparks. A spark requires a sufficiently high electric field throughout the gas gap before it can form. The sparking event is disadvantageous for a number of reasons; it is a high temperature and destructive event, it creates unwanted electro-magnetic interference (EMI), it consumes power without producing meaningful work on the gas. By eliminating the field concentrations at the collector, the sparking events will occur at high voltages, leaving the corona wind device with a larger operating window and a higher mechanical output.

The present invention is applicable to corona discharge as described in this disclosure and finds particular utility in an electrostatic air pump (fan). The gap from the corona electrode collector electrode ranges from 0.5 to 5 mm. The voltages will range from 300 to 5000 V. The present invention is not this application, however.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. An ion wind fan comprising:
a collector electrode having a radial contour and a rounded azimuthal edge.

2. The ion wind fan of claim 1, wherein the collector electrode having a radial contour comprises the collector electrode having a substantially semi-cylindrical shape.

3. The ion wind fan of claim 2, further comprising a corona electrode, wherein the corona electrode comprises a wire disposed lengthwise along a lengthwise direction of the semi-cylindrical shaped collector electrode.

4. The ion wind fan of claim 3, wherein the collector electrode having a rounded azimuthal edge comprises the collector having a rounded profile facing the corona electrode at the edge where the semi-cylinder shape terminates.

5. An ion wind fan comprising:
a collector electrode; and
a corona electrode having a length and two end portions, wherein the end portions of the corona electrode are electrically insulated and a center portion of the corona electrode is exposed.

6. The ion wind fan of claim 5, wherein ions are generated only along the exposed center portion of the corona electrode during operation of the ion wind fan.

7. The ion wind fan of claim 5, wherein the two end portions are axially opposite ends of the corona electrode.

8. The ion wind fan of claim 5, wherein the collector electrode has a length that is shorter than the length of the corona electrode.

9. The ion wind fan of claim 5, wherein the collector electrode has a length that is shorter that the length of the exposed center portion of the corona electrode.

10. A method of controlling the electric field in a corona wind fan to eliminate sparks and thereby increase the operating window and mechanical output of the device, comprising:
adding a rounded section at the azimuthal edge of a contoured electrode.

11. The method of claim 10, wherein the contoured electrode is radially contoured.

12. The method of claim 10, wherein the contoured electrode is spherically contoured.

13. The method of claim 10, wherein a radius of the rounded section provides a ½ round feature.
